(19) United States
(12) Patent Application Publication
(10) Pub. No.: US 2025/0211714 A1
(43) Pub. Date: Jun. 26, 2025

(54) DIRECTION TRACKING WEARABLE CAMERA

(71) Applicant: RealWear, Inc., Vancouver, WA (US)

(72) Inventor: Chris Iain PARKINSON, Richland, WA (US)

(21) Appl. No.: 18/391,315

(22) Filed: Dec. 20, 2023

(51) Int. Cl. H04N 7/18; H04N 23/58; H04N 23/61

(52) U.S. Cl. CPC H04N 7/185; H04N 23/58; H04N 23/61

(57) ABSTRACT

Systems, methods, and media are provided for reducing live video imagery captured by a camera for display on a remote display device, which can provide an indication of what is being seen by the user versus what is being captured by the camera. A wearable camera can be paired with a tracking device that tracks the position of a user's head relative to the camera. Reduced live video imagery is then transmitted to provide a portion of the live video imagery that more accurately depicts what the user is looking at, as opposed to the entire field of view being captured by the camera.

### BACKGROUND

Wearable cameras are commonplace. Wearable cameras are devices that generally allow a user to capture imagery within a field of view (FOV) of the camera. Many wearable cameras today are associated with recording recreational activities such as skiing or hiking. In other capacities, wearable cameras are used to capture professional settings during working hours. For example, employers might require employees to utilize a wearable camera when they are performing work in factories or on construction sights. An advantage of requiring employees to wear cameras while on the job is that the tasks performed are recorded and can be available for viewing at a later time.

### SUMMARY

At a high level, aspects described herein relate to capturing a FOV with a camera and reducing that FOV for display on a remote display device. The imagery displayed on the remote display device is a reduction of the FOV of the camera, and the reduced view is based on the physical position of a tracking device that can be worn by a user in relation to the physical position of the camera that can similarly be worn by a user. Based on this relation, the FOV of the camera is reduced to capture what the user is looking at, thus allowing a remote viewer to view a live video stream corresponding to what the camera wearer sees, rather than everything the body-worn camera is capable of capturing. Knowing what the user is looking at aids in enhancing the overall communication between the user and the remote viewer.

In an embodiment, a user wears a wide-angle camera that captures video over a wide FOV, which is generally wider than what can be seen by the wearer. Additionally, a tracking device is worn that tracks the wearer's head movement relative to the camera. By determining the tracking device position relative to the camera, the wide FOV captured by the camera can be reduced to a reduced imagery view, which is a live video segment of the total imagery captured from the FOV of the camera. As the wearer moves his or her head, the relative position of the tracking device changes, and the live video segment changes accordingly to better corresponding to what the wearer is looking at. The live video segment is transmitted to a remote display. In this way, the live video segment as displayed on the remote display device better depicts what the camera wearer actually views, while still being able to capture a wider FOV angle by the camera.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 illustrates an example set of tracking devices suitable for use by aspects of the technology, in accordance with an aspect described herein;

FIG. 3 illustrates an example camera suitable for use by aspects of the technology, in accordance with an aspect described herein;

FIG. 4 illustrates an example live video imagery view being captured within a FOV of a camera, in accordance with an aspect described herein;

FIG. 5A illustrates an example reduced live video imagery view at a first position of a tracking device relative to the camera, in accordance with an aspect described herein;

FIG. 5B illustrates another example reduced live video imagery view at a second position of the tracking device relative to the camera, in accordance with an aspect described herein;

FIG. 5C illustrates another example reduced live video imagery view at a third position of the tracking device relative to the camera, in accordance with an aspect described herein;

FIGS. 6 and 7 illustrate block diagrams having various example methods for capturing and transmitting a reduced live video imagery view, in accordance with aspects described herein; and

FIG. 8 illustrates an example computing device suitable for implementing aspects of the technology, in accordance with an aspect described herein.

### DETAILED DESCRIPTION

Wearable cameras, sometimes referred to as bodycams or body-worn cameras, are small, portable devices worn by individuals. Wearable cameras record audio and live video imagery of interactions between individuals and their environments. Individuals use wearable cameras to document their daily activities, travel experiences, or special events hands-free. This can provide a first-person perspective and capture moments from a user's point of view. Athletes and outdoor enthusiasts use wearable cameras to capture their activities, whether it is mountain biking, skiing, or other adventurous pursuits. In fields like journalism, healthcare, or public safety, wearable cameras can be used to record events, interviews, medical procedures, or law enforcement activities. This footage can serve as documentation, training material, or evidence. In educational settings, wearable cameras can be used by teachers or students to capture classroom activities, experiments, or field trips. This footage can aid in reviewing and improving educational practices.

The field of view (FOV) of a conventional camera ranges, and the FOV of a wide-angle camera is typically greater than 60 degrees. Some wide-angle cameras have a FOV of 90 degrees or greater (known as ultra-wide-angle cameras), and some wide-angle cameras (known as omnidirectional cameras) are capable of capturing all 360 degrees. For comparison, humans have generally between 170 and 180 degrees of total visual field. Although a field of vision of a human is relatively wide, the focus area is much smaller. For example, a human's central vision includes the inner 30 degrees of the entire field of vision and also includes central fixation, which essentially best represents what someone is looking at. Within a human's central vision is what is called foveal vision, which is where maximum visual acuity is achieved. This maximum acuity of vision only occupies about 1-3 degrees of a human's entire visual field. As can be seen, wide-angle cameras are capable of capturing a greater FOV than the field of vision of a human, especially greater than the area that the human is focused on.

Wearable cameras can capture live video imagery that is transmitted in real-time and displayed on a display device so that a remote viewer can witness what the person wearing the camera is doing and communicate with that person. This may be done in situations where the remote viewer provides guidance or directions to the person wearing the camera, especially if the person wearing the camera is in an unfamiliar environment or engaged in a specific task. For example, in cases of emergencies or unforeseen events, the remote viewer might need to communicate with the person wearing the camera to ensure safety, provide instructions, or request assistance. In other use-case examples, a remote viewer guides a worker on how to fix or maintain something. Moreover, the remote viewer might want additional information or clarification about what the wearer is actively seeing. If the person wearing the camera is involved in a situation that requires decision-making, the remote viewer may offer advice or support to help them make informed choices. The viewer might want to coordinate actions, discuss observations, or provide input based on what they see in the live video imagery.

Furthermore, wide-angle cameras are valuable tools for capturing a sense of space, context, and the overall environment. For instance, wide-angle cameras are ideal for capturing expansive areas or providing a large amount of information. There are benefits to wearing wide-angle cameras in remote viewing scenarios. These cameras capture a wide area, and can thus record a large amount of information and imagery around the person wearing the camera. The imagery captured by the camera may be a live video.

However, wide-camera-angle technology often captures a wider FOV than what a person can normally look at, especially a wider FOV than what a person is visually focused on. Thus, there are areas within the FOV of a wide-angle camera that the person wearing the camera cannot see without turning their head. This distortion can create confusion in cases where a remote viewer viewing what is being captured by the camera is communicating to the camera wearer about objects captured by the camera. That is because the object may be viewable in the live-stream video, but not in the focus or line of sight of the person wearing the camera.

For example, a worker at a construction site could be wearing a wearable camera that transmits the entire FOV of the camera for display on a remote display device. Without reducing the FOV of the camera, a remote viewer watching from the display device would see the all of the live video imagery that the camera captures. If the remote viewer tried to communicate with the construction worker regarding an aspect of the construction site, the remote viewer would not know where the construction worker was looking. Similarly, the worker wearing the camera would likely need guidance from the remote viewer to explain specifically what the remote viewer is referring to. In other words, confusion will likely arise if the remote viewer is seeing more than what is in the wearer's focus or line of sight.

To address this issue, aspects of the technology provide a tracking device and determine its position relative to the camera. Based on this, the live video imagery being displayed on the display device can be reduced to show what the user is looking at. This way, both the user and the remote viewer will be looking at the same thing (i.e., the remote viewer would be seeing what the construction worker is seeing). Knowing what the user is looking at can reduce confusion for someone that is communicating with the camera wearer. Many current technologies do not distinguish between what is being captured by the camera versus what is being seen by the user.

In an example of the technology, a wearable camera can be paired with a tracking device that tracks the position of the person's head relative to the camera. The position of the person's head relative to that of the camera can provide an indication of what is being seen by the user versus what is being captured by the camera. When transmitting imagery from the camera to a remote viewer, the imagery is reduced so that it provides a portion of the live video feed more accurately depicting what the user is looking at, as opposed to the entire FOV being captured by the camera, which likely includes objects the person is not viewing or focused on at that moment.

A tracking device can be any type of headgear. Various types of headgear that can be used as tracking devices include headphones, headsets, hats, helmets, glasses, headbands, hair accessories, crowns or tiaras, face shields, visors, masks, and other ornaments or devices that can be worn on the head.

The tracking device position is determined by positional tracking technology. Some positional tracking devices work by continuously determining the position and orientation of an object or user in a given space. There are different technologies and methods for achieving positional tracking. One common approach is to use external sensors or markers in combination with internal sensors on the tracked object (i.e., the tracking device that the user is wearing). In other embodiments, the tracking device is equipped with an inertial measurement unit, which often include accelerometers or gyroscopes. These sensors measure the acceleration and angular velocity of the tracking device, respectively. Some tracking devices also include magnetometers. Magnetometers are used to measure the strength of the magnetic field in a particular location, which can help determine the orientation of the tracking device. In yet another aspect, the camera and the tracking device may be paired using a short-range communication protocol, such as Bluetooth. For instance, the relative position may be determined using signal strength indications measured from the strength of the connection between the devices. Other embodiments of a tracking device include different methods for determining and refining the tracking device position, such as sensor fusion, update loops, and calibration processes.

While the tracking device position is determined by using a positional tracking method like the ones mentioned above, in an aspect, a similar tracking method could be incorporated into the camera and used to determine the position of the camera. Further, the tracking device position is determined based on movement of the tracking device relative to movement of the camera.

Therefore, when a user who is wearing a camera and a tracking device that tracks the position of the person's head relative to the camera turns their head, the tracking device changes position relative to the camera. Based on the relative change in the tracking device position, the live video imagery being captured with a FOV of the camera will be reduced corresponding to the changed position. As a result, a wide-angle view of a large area of a location of a user with a body-worn camera is reduced to better show what the user is looking at. Accordingly, a remote viewer watching the live video feed is able to better distinguish what is being captured by the camera and what is being seen by the user. This provides a way to capture video of a large area surrounding the wearer, while at the same time providing needed context to a remote viewer who can better view what the camera wearer is actually looking at.

When the remote viewer is able to distinguish what is being captured by the camera and what is actually being seen by the user, that remote viewer may effectively communicate with the user. That remote viewer may provide sound guidance, direction, or instruction to the person wearing the camera to ensure safety, request additional information, or make informed decisions. That viewer could coordinate actions, discuss observations, or provide input based on what they see in the live video imagery. Knowing what is in the user's line of sight or what the user is focused on reduces confusion for the remote viewer communicating with that user, and that knowledge also aids in enhancing the overall communication between the user and the remote viewer.

It will be realized that the method previously described is only an example that can be practiced from the description that follows, and it is provided to more easily understand the technology and recognize its benefits. Additional examples are now described with reference to the figures.

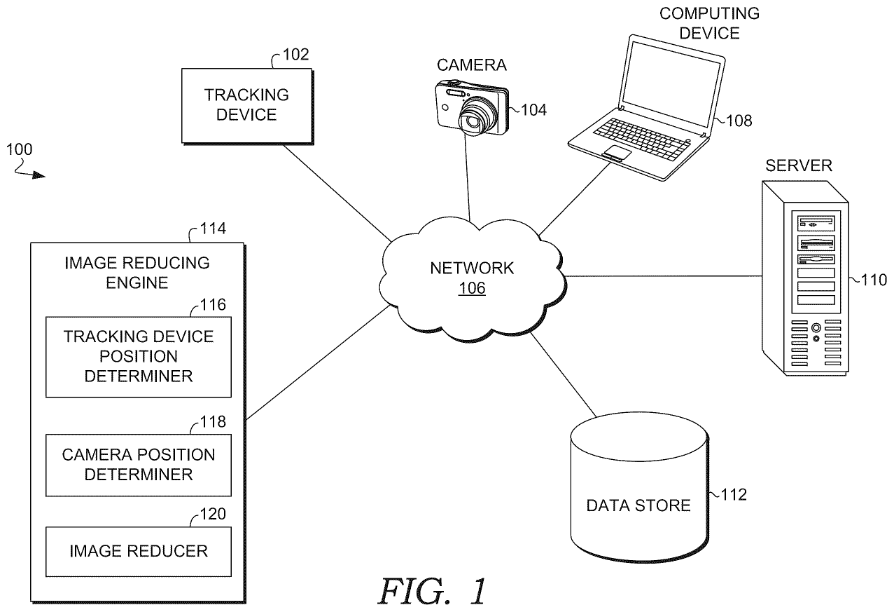

With reference now to FIG. 1, an example operating environment 100 in which aspects of the technology may be employed is provided. Among other components or engines not shown, operating environment 100 comprises tracking device 102, camera 104, computing device 108, server 110, and data store 112, which are communicating via network 106 to image reducing engine 114.

Data store 112 generally stores information, including data, computer instructions (e.g., software program instructions, routines, or services), or models used in embodiments of the described technologies. For instance, data store 112 may store computer instructions for implementing functional aspects of image reducing engine 114. Although depicted as a single data store component, data store 112 may be embodied as one or more data stores or may be in the cloud.

Network 106 may include one or more networks (e.g., public network or virtual private network [VPN]), as shown with network 106. Network 106 may include, without limitation, one or more local area networks (LANs), wide area networks (WANs), or any other communication network or method.

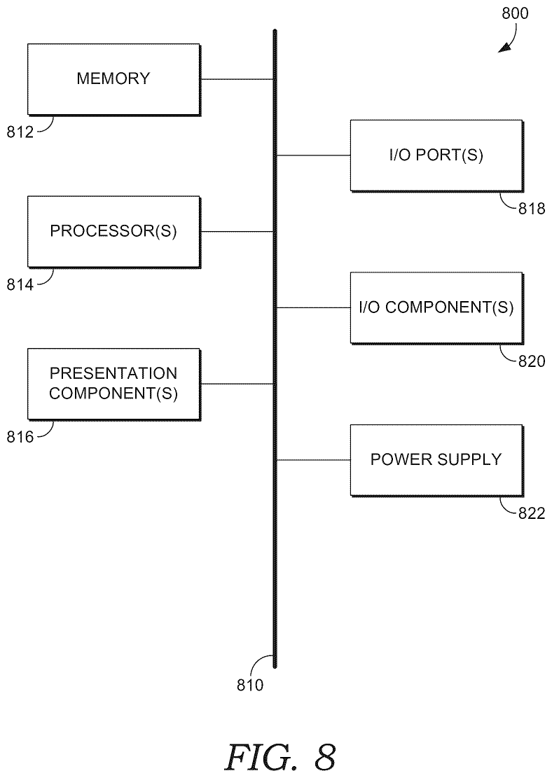

Generally, server 110 is a computing device that implements functional aspects of operating environment 100, such as one or more functions of image reducing engine 114 to facilitate the reduction of the FOV of camera 104 based on the position of a tracking device 102 in relation to the position of the camera 104. One suitable example of a computing device that can be employed as server 110 is described as computing device 800 with respect to FIG. 8. In implementations, server 110 represents a backend or server-side device. In some embodiments, server 110 can be a processor. In an aspect, sever 110 is a smartphone receiving positional information from tracking device 102, camera 104, or both. In an aspect, server 110 is wirelessly coupled to tracking device 102, camera 104, or both, and server 110 is communicating the captured live video imagery and positional information for reducing, or is reducing the live video imagery for display, and is transmitting the live video imagery (e.g., via a cellular or satellite network).

Computing device 108 is generally a computing device that may be used to display live video imagery on a display device, among other functions. Computing device 108 may receive and display items as reduced live video imagery from image reducing engine 114. In an aspect, computing device 108 comprises an audio input component to facilitate two-way communication with a communication device of a camera wearer. Thus, in aspects, computing device 108 can be used by a remote viewer to receive and view reduced live video imagery (i.e., a live stream video segment) captured by the camera 104.

As with other components of FIG. 1, computing device 108 is intended to represent one or more computing devices. One suitable example of a computing device that can be employed as computing device 108 is described as computing device 800 with respect to FIG. 8. In implementations, computing device 108 is a client-side or front-end device. In addition to server 110, computing device 108 may implement functional aspects of operating environment 100, such as one or more functions of image reducing engine 114. It will be understood that some implementations of the technology will comprise either a client-side or front-end computing device, a backend or server-side computing device, or both executing any combination of functions from image reducing engine 114, among other functions or combinations of functions.

In general, tracking device 102 may be a tracking device having a position that can be determined relative to the camera 104. One example of a suitable tracking device that may be used is a headset with position tracking features. One example uses accelerometers, gyroscopes, or magnetometers to track the position of the headset. Tracking device 102 may also use short range communication protocols, such as Bluetooth, to pair or communicate with other devices for use in determining the relative position of the tracking device 102, such as pairing or communicating with the camera 104 or the server 110.

In general, camera 104 may be a camera that captures and transmits imagery. In an aspect, camera 104 is a wide-angle camera and has a FOV that is greater than 60 degrees. One example that may be suitable is a camera with a focal length of 35 mm or shorter. Another example that may be suitable is the camera of a cellular device. The imagery being captured by camera 104 may be a live video. Camera 104 can capture live video of an area surrounding the wearer, but that area can be reduced for transmission to provide context to a remote viewer who can better view what the camera wearer is actually looking at. When the remote viewer is able to distinguish what is being captured by the camera and what is actually being seen by the user, that remote viewer may effectively communicate with the user.

Broadly, image reducing engine 114, either individually or in coordination with other components or systems, determines the position of tracking device 102 in relation to camera 104 and reduces the live video imagery captured by camera 104 to an area within the FOV of camera 104. In doing so, image reducing engine 114 reduces the live video imagery captured with the FOV of camera 104 to an area that better reflects the focus or line of sight of a user. Image reducing engine 114 is intended to be only an example system for reducing live video imagery based on a relative location of tracking device 102. Functions described with respect to image reducing engine 114 may be performed by various devices, including those illustrated in FIG. 1, such as the tracking device 102, the camera 104, the computing device 108, and the server 110, or combinations of these components. Thus, live video imagery may be reduced based on the relative position of tracking device 102 using hardware of the tracking device 102 or camera 104, and provided to computing device 108. In another implementation, sever 110 reduces the live video imagery using positional information received from the tracking device 102 or camera 104, and provides the reduced live video imagery to the computing device 108. Other combinations of functions may be performed and will be understood to those of ordinary skill.

In the example image reducing engine 114 illustrated, tracking device position determiner 116 determines the position of tracking device 102, and camera position determiner 118 determines the position of camera 104. In an example, tracking device position determiner 116 and camera position determiner 118 both utilize inertial motion tracking to determine the position of the object(s) subject to tracking (here, tracking device 102 and camera 104, respectively).

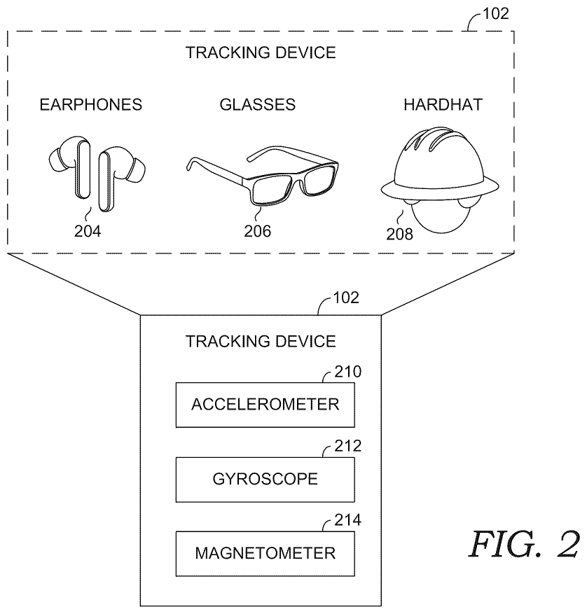

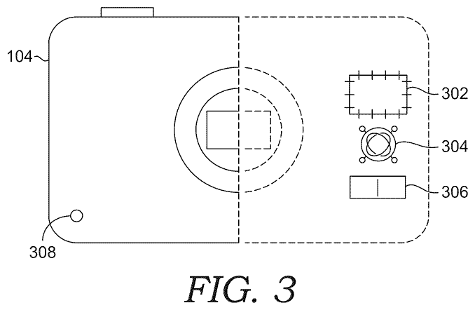

Tracking may be done using a position tracking component—such as an accelerometer, a gyroscope, or a magnetometer—that is physically placed on or within the object being tracked (tracking device 102 or camera 104). For instance, tracking device position determiner 116 can utilize the position tracking components of tracking device 102 (referring briefly now to FIG. 2), which can include accelerometer 210, gyroscope 212, and magnetometer 214, to track (i.e., measure the position or relative position of) tracking device 102 in three-dimensional space. Likewise, camera position determiner 118 can utilize the position tracking components of camera 104 (referring briefly now to FIG. 3), which can include accelerometer 302, gyroscope 304, and magnetometer 306, to similarly track camera 104 in three-dimensional space. Accordingly, via tracking device position determiner 116 and camera position determiner 118, image reducing engine 114 will determine the position of tracking device 102 in relation to camera 104.

Motion tracking of each component is just one example in which tracking device position determiner 116 and camera position determiner 118 can determine the positions of tracking device 102 and camera 104, respectively, or the relative positions thereof. In addition, there are different technologies and methods that can be used to enable tracking device position determiner 116 and camera position determiner 118. In an aspect, external sensors or markers can be used in combination with internal sensors on tracking device 102 and camera 104, enabling the operations of both tracking device position determiner 116 and camera position determine 118.

In yet another aspect, tracking device 102 and camera 104 may be paired using a short-range communication protocol, such as Bluetooth. For instance, using signal strength indications measured from the strength of the connection between the devices the position of the tracking device 102 relative to the camera 104 can be determined. Other embodiments of tracking device position determiner 116 determining the position of tracking device 102 and camera position determiner 118 determining the position of camera 104 include different methods for determining and refining the position of an object, such as sensor fusion, update loops, and calibration processes.

Based on the position of tracking device 102 relative to camera 104, image reducing engine 114 reduces the live video imagery captured by camera 104 via image reducer 120 to an area within the live video imagery captured within the FOV of camera 104. Image reducer 120 identifies imagery that is being received that was captured using a FOV of camera 104. The imagery of camera 104 may be a live video.

In an aspect, image reducer 120 determines that the FOV of camera 104 is greater than a threshold value. For example, if the threshold value is set at 60 degrees, then live video imagery received from a camera with a FOV of 120 degrees would trigger image reducer 120 to reduce the imagery. Other threshold FOV values may cause image reducer 120 to reduce the live video imagery captured by camera 104, such as 90 degrees, 120 degrees, 150 degrees, and so forth. If live video imagery is being received from camera 104 having a FOV that exceeds the threshold value, image reducer 120 can reduce the live video imagery to a reduced live video imagery view within the FOV of camera 104.

Image reducer 120 can identify a location within the FOV of camera 104 that corresponds to the relative tracking device position of tracking device 102 (determined by tracking device position determiner 116) in relation to the position of camera 104 (determined by camera position determiner 118), or based on another method of determining the relative position of the tracking device 102. Based on the position of tracking device 102 relative to camera 104, image reducer 120 can then determine an area around the location within the FOV of camera 104 that has a reduced set of dimensions relative to the FOV of the camera. The live video imagery is then reduced corresponding to this determined area. This reduced live video imagery view is a live stream video segment of the FOV of camera 104 and is transmitted for display on a remote display device, such as a display of the computing device 108.

It is again noted that image reducing engine 114 is intended to be one example suitable for implementing the technology. However, other arrangements and architectures of components and functions for reducing the FOV of a camera based on the position of a tracking device in relation to the position of a camera are intended to be within the scope of this disclosure and understood by those practicing the technology. For instance, in a specific example, the camera 104 is paired with the tracking device 102 via a short range communication protocol, such as Bluetooth. This paring allows camera 104 to determine the relative position of the tracking device 102 to the camera 104 based on the strength of the connection. The relative position can be used to reduce the live video imagery captured by the camera 104 or communicated to other components of operating environment 100 for reducing the live video imagery. In another example, the tracking device 102 determines the relative location of the camera 104 based on the shortwave communication protocol and reduces, or provides for reduction, the live video imagery.

With reference now to FIG. 2, an example tracking device 102 in which aspects of the technology may be employed is provided. FIG. 2 illustrates an example tracking device 102 with position tracking components. One suitable example of a position tracking component is accelerometer 210. An accelerometer may be used to measure and detect changes in acceleration, enabling accelerometers to be used in identifying a position or relative position of a device. Another example of a position tracking component is gyroscope 212. A gyroscope may be utilized to measure and maintain orientation in various devices. Another suitable example of a position tracking component is magnetometer 214. A magnetometer may be used to measure the strength of the magnetic field in a particular location, which can help determine the orientation and position of the tracking device 102.

An example tracking device 102 in which aspects of the technology may be employed is provided in FIG. 2. Tracking device 102 is generally a device in which the position of the device may be determined relative to that of the camera 104. The tracking device position can be determined based on movement of the tracking device 102 relative to movement of the camera 104. In aspects, tracking device 102 is positioned onto a person's head and used to track head movements by determining the position of the tracking device relative to the camera. For instance, earphones 204, glasses 206, or hardhat 208 are some examples of objects that can include components for tracking the object's position and may thus be suitable for use as tracking device 102 in some aspects. These are just some examples among many objects that may be used or enabled as tracking device 102. In addition to these position tracking components, tracking device can include a microphone to capture live audio and also a speaker so that the user can engage in two-way audio communication with a remote viewer.

With reference now to FIG. 3, an example camera 104 in which aspects of the technology may be employed is provided. Camera 104 is generally a camera in which the position of the camera may be determined relative to that of the tracking device 102. In an aspect, the camera position can be determined based on movement of the tracking device 102 relative to movement of the camera 104. In aspects, camera 104 is a wearable camera positioned onto a person's chest or other area of the body and its position is determined relative to the tracking device 102, which may be worn on a person's head. In an embodiment, camera 104 includes similar position tracking components to tracking device 102, including, but not limited to, accelerometer 302, gyroscope 304, and magnetometer 306. Along with these position tracking components, camera 104 can also include microphone 308 to capture live audio in addition to the live video imagery being captured by camera 104.

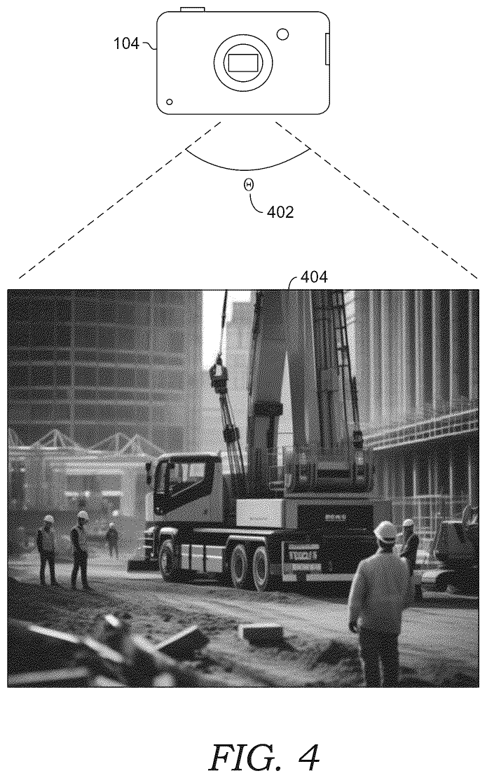

With reference now to FIG. 4, an example FOV 402 of camera 104 is illustrated. The Greek letter Θ (theta) represents the degrees of FOV 402 of camera 104. In embodiment using wide-angle cameras, the FOV 402 of camera 104 is generally greater than 60 degrees. In aspects, the imagery captured by camera 104 may be a live video. Furthermore, camera 104 captures live video imagery 404 within FOV 402. Live video imagery 404 is anything captured within FOV 402 of camera 104. For illustrative purposes and context, a construction scene with three construction workers is provided as live video imagery 404 within FOV 402 of camera 104. As noted, camera 104 may be worn by a wearer. Various devices capable of capturing imagery may be utilized as camera 104, and such devices may be worn in various places when in use.

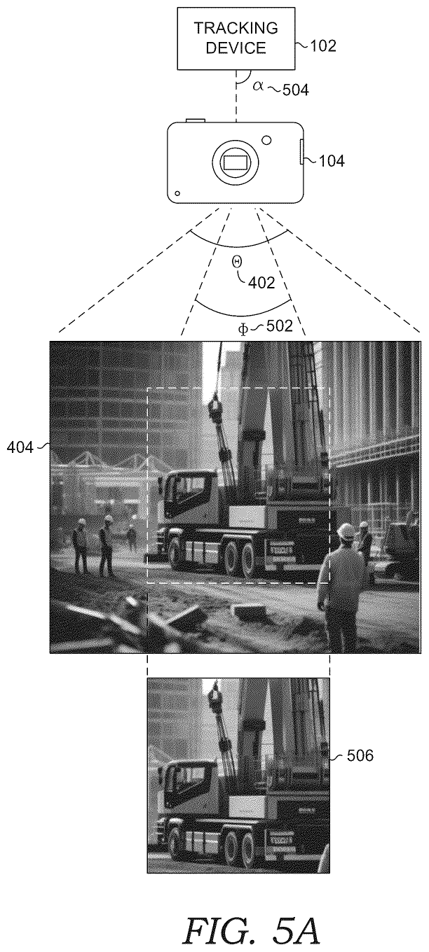

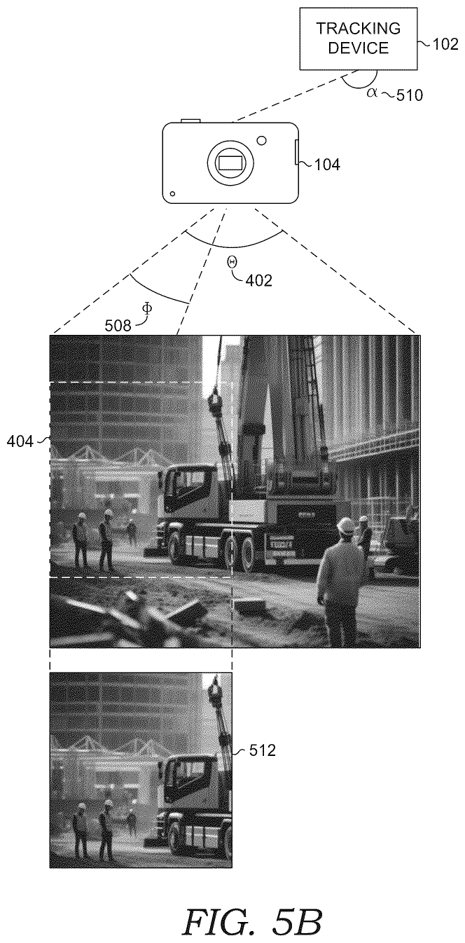

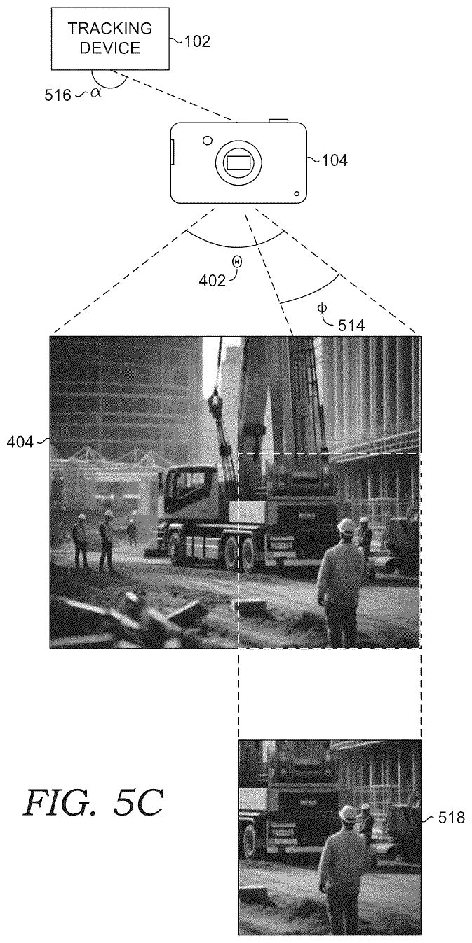

With reference now to FIG. 5A, an example first reduced live video imagery view 506 of live video imagery 404 is provided. A reduced live video imagery view is a live stream video segment of the FOV 402 of the camera 104. The Greek letter Φ (phi) represents a first reduced set of dimensions 502 within FOV 402 of camera 104. In general, a reduced set of dimensions is less than FOV 402. Furthermore, a reduced set of dimensions within FOV 402 of camera 104, such as the first reduced set of dimension 502, may capture any portion within the FOV 402 of camera 104, including anywhere in the horizontal or vertical direction with the FOV 402 of camera 104. And thus, Φ is representative of any angle across either the horizontal or vertical dimensions of a two-dimensional live video imagery. As such, a reduced live video imagery view, such as first reduced live video imagery view 506, may include a reduced set of dimensions along the vertical axis, the horizontal axis, or both of the live video imagery.

In some embodiments, FOV 402 is greater than 60 degrees, and the first reduced set of dimensions 502 is less than 60 degrees. As noted, camera angles for wide-angle cameras may have various different degrees of FOV. Thus, in some embodiments, FOV 402 may be greater than 90 degrees, greater than 120 degrees, greater than 150 degrees, greater than 180 degrees, greater than 210 degrees, and so forth. Any wide-angle camera may be used. Moreover, as noted, the first reduced set of dimensions 502 is less than FOV 402, and thus, respectively, the first reduced set of dimensions 502 may be less than 90 degrees, less than 120 degrees, less than 150 degrees, less than 180 degrees, less than 210 degrees, and so forth. While the field of vision of a human is relatively wide, the focus area is much smaller and could be less than 30 degrees of the entire field of vision. As such, reduction of the FOV 402 of camera 104 to a reduced set of dimensions, such as the first reduced set of dimensions 502, may provide additional context to or otherwise indicate what the person wearing the camera 104 is looking at.

Moreover, the first reduced set of dimensions 502 within FOV 402 of camera 104 corresponds to a first position 504 of tracking device 102 in relation to camera 104. The first position 504 between tracking device 102 and camera 104 is represented by the Greek letter α (alpha). Notably, the first position 504 of tracking device 102 in relation to camera 104 is determined by components of image reducing engine 114. In other words, image reducing engine 114 determines a change in the tracking device position relative to the camera.

Using the first position 504 relative to that of the camera 104, image reducer 120 can identify a location within the FOV 402 of the camera 104 based on first position 504. Based on first position 504, image reducer 120 can determine an area around the location within the FOV 402 of camera 104 that has the first reduced set of dimensions 502 within the FOV 402 of the camera 104. The area around the location may be determined using Φ. Corresponding to this determined area, live video imagery 404 is reduced to first reduced live video imagery view 506. This first reduced live video imagery view 506 is a live stream video segment of the FOV 402 of camera 104 and is transmitted for display on a remote display device, such as a display of the computing device 108.

For example, as illustrated in FIG. 5A, the first position 504 of tracking device 102 is in line with the camera 104. In other words, for example, a user wearing camera 104 on his or her chest while also wearing tracking device 102 on his or her head is facing forward. Therefore, in this illustration, the user is looking straight ahead, which in this case means that the crane truck in the middle of the FOV 402 of camera 104 is directly in the user's line of sight. Based on this first position 504, image reducing engine 114 reduces live video imagery 404 to first reduced set of dimensions 502 and transmits the first reduced live video imagery view 506 for display on a display device, such as a display of the computing device 108. Therefore, while camera 104 can capture live video of an area surrounding the wearer, e.g., capturing a FOV greater than the visual focus or viewing angle of the wearer, the area (i.e., live video imagery 404) can be reduced (i.e., to first reduced live video imagery 506) for transmission to provide context to a remote viewer who can better view what the camera wearer is actually looking at. When the remote viewer is able to distinguish what is being captured by the camera and what is actually being seen by the user, that remote viewer may effectively communicate with the user.

In another example, referring now to FIG. 5B, a second position 510 (a) between tracking device 102 and camera 104 represents the user turning his or her head to one side. Therefore, because the user has turned his or her head and is focused on a different portion of FOV 402 of camera 104, tracking device 102 is now positioned in the second position 510 relative to camera 104. Moreover, in an embodiment, image reducing engine 114 will receive feedback from the position tracking components in tracking device 102 or camera 104 relaying the new relative position of the tracking device 102. In other words, image reducing engine 114 determines the new position (i.e., second position 510 in this example) of tracking device 102. Based on second position 510, image reducing engine 114 reduces the live video imagery 404 via image reducer 120 to the second reduced set of dimensions 508 (Φ) and transmits the second reduced live video imagery view 512 for display on a display device. As a result, in this example, because the user is looking at the two construction workers standing next to the crane truck on the left side of the construction site within FOV 402 of camera 104, the two construction workers standing next to the crane truck within the line of sight of the user is what is displayed for viewing on the remote display device.

In yet another example, referring now to FIG. 5C, a third position 516 (a) between tracking device 102 and camera 104 represents the user turning his or her head down and to the other side. The user will often be turning his or her head to focus on something within his or her line of sight. Said differently, users will continuously adjust their focus and the direction of view. An advantage of the present disclosure is that, based on the position of tracking device 102 in relation to camera 104, image reducing engine 114 may continuously reduce the live video imagery to a segment of the live video imagery for display on a remote display device whenever the FOV 402 of camera 104 is greater than a predetermined threshold value.

As illustrated in FIG. 5C, the user has turned his or her head down and from one side (depicted in FIG. 5B) to a different side. This change in the user's focus or line of sight is the third position 516 (a). Here, image reducing engine 114 determines the new position (i.e., third position 516) of tracking device 102 in relation to camera 104. Because the user has turned to focus on another area within FOV 402 of camera 104, the corresponding segment within FOV 402 is what will be displayed for viewing on the remote display device. In other words, based on the third position 516, image reducing engine 114 will reduce the live video imagery 404 to the third reduced set of dimensions 514 (Φ) and transmit a segment of live video imagery 404 (i.e., the third reduced live video imagery view 518) for display on a display device. Said in another way, a different reduced live video imagery view corresponding to the changed position of the tracking device is transmitted for viewing by a remote viewer.

As illustrated in the example, the user has adjusted his or her head to focus on another area of the construction scene. In response, image reducing engine 114 determines the new position (third position 516) and reduces the live video imagery 404 to the third reduced set of dimensions 514 and transmits the third reduced live video imagery view 518 (the construction worker standing straight up and looking toward the construction site) for display on a display device. Based on the third position 516, a remote viewer can focus in on the construction worker who is depicted in the third reduced live video imagery view 518. There are numerous advantages to the remote viewer to see what is in the user's line of sight. In this example, the remote viewer could be in communication with the user. The remote viewer might need to communicate with the user to ensure safety protocols are followed, provide instructions on how to fix or maintain something, or request additional information or clarification about things going on at the construction site. In a situation that requires decision-making, the remote viewer may offer advice or support to help the user make informed choices.

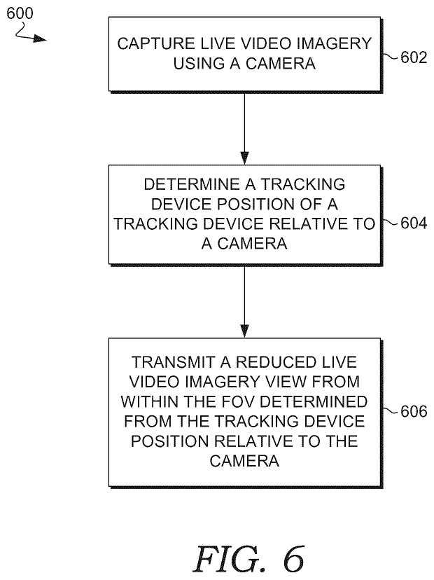

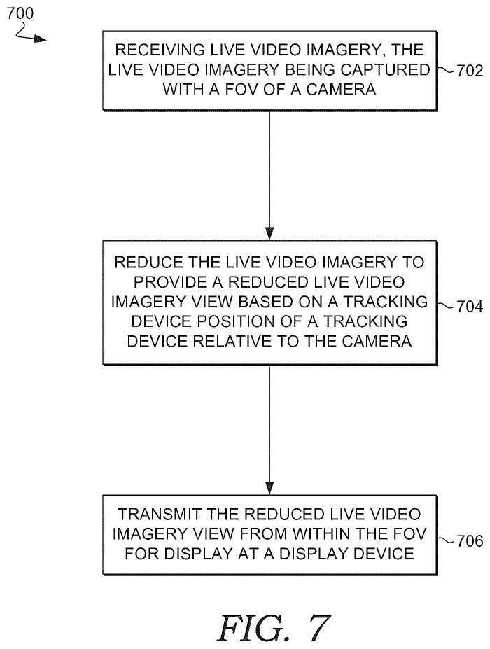

Referring now to FIGS. 6 and 7, flow diagrams are provided respectively illustrating methods 600 and 700. Each block of method 600 and method 700 may comprise a computing process performed using any combination of hardware, firmware, or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities. Method 600 and method 700 may be implemented in whole or in part by components of operating environment 100.

Referring now to FIG. 6, a flow diagram is provided with an example method 600 for capturing live video imagery and transmitting a reduced live video imagery view. At block 602, live video imagery is captured by a camera. An example camera capable of capturing live video imagery is camera 104. The camera may be a wide-angle camera. The camera may be a wearable camera capturing live video imagery of an area near a wearer.

At block 604, a tracking device position of a tracking device relative to a camera is determined. For instance, image reducing engine 114 may determine the relative position of a tracking device in relation to a camera by utilizing tracking device position determiner 116 to determine the position of the tracking device and by utilizing camera position determiner 118 to determine the position of the camera. For example, tracking device position determiner 116 may determine the position of tracking device 102 by using position tracking components within or on the tracking device 102. In an aspect, tracking device position determiner 118 may utilize position tracking components such accelerometers, gyroscopes, and magnetometers. Examples of tracking devices with tracking components are found in FIG. 2, and tracking device 102 is an example. In some aspects, the camera position of a camera is determined by camera position determiner 118 utilizing position tracking components within or on the camera, and FIG. 3 illustrates camera 104 as an example of a camera with position tracking components that are capable of determining the position of the camera. The relative position of the camera is then known based on the position of the tracking device and the position of the camera. In other words, the relative positions of the camera and the tracking device are based on movement of tracking device 102 relative to movement of camera 104. In other aspect, the camera and the tracking device communicate using a shortwave communication protocol. Using the relative strength of the communications, the position of the tracking device is determined relative to the position of the camera.

At block 606, based on the tracking device position of the tracking device relative to the camera, image reducing engine 114 reduces the live video imagery captured by the camera to an area within the live video imagery captured within the FOV of the camera. For instance, image reducer 120 of image reducing engine 114 determines that the FOV of the camera is greater than a threshold value. If live video imagery is being received from a camera having a FOV that exceeds the threshold value, image reducer 120 can reduce the live video imagery to a reduced live video imagery view within the FOV of the camera. Image reducer 120 can identify a location within the FOV of camera 104 that corresponds to the relative tracking device position of tracking device 102 in relation to the position of a camera. Based on the position of the tracking device relative to the camera, image reducer 120 can then determine an area around the location within the FOV of camera 104 that has a reduced set of dimensions relative to the FOV of the camera. The live video imagery is then reduced to a reduced live video imagery view (i.e., a live stream video segment) within the FOV of the camera, which is then transmitted for display on a remote display device, such as a display of the computing device 108. Any hardware connected to network 106 that is capable of transmitting, including tracking device 102, camera 104, computer device 108, or server 110, can undertake and perform the transmission of the reduced live video imagery for display on a display device.

Referring now to FIG. 7, a flow diagram is provided with an example method 700 for receiving live video imagery and transmitting a reduced live video imagery view. At block 702, live video imagery captured with a FOV of a camera is received. An example camera capable of capturing the received live video imagery is camera 104.

At block 704, the live video imagery being received is reduced via image reducer 120 to an area within the live video imagery captured within the FOV of the camera. Image reducer 120 reduces the live video imagery being received to a reduced live video imagery view based on the tracking device position of the tracking device relative to the camera. The relative positions of the camera and the tracking device are known based on the position of the tracking device (determined by tracking device position determiner 116, for example) and the position of the camera (determined by camera position determiner 118, for example). In other aspect, the camera and the tracking device communicate using a shortwave communication protocol. Using the relative strength of the communications, the position of the tracking device is determined relative to the position of the camera.

At block 706, the reduced live video imagery view, having been reduced to an area within the live video imagery captured within the FOV of the camera, is then transmitted for display on a remote display device. The reduced live video imagery view is a live stream video segment of the FOV of the camera. Any hardware connected to network 106 that is capable of transmitting, including tracking device 102, camera 104, computer device 108, or server 110, can undertake and perform the transmission of the reduced live video imagery for display on a display device.

Having described an overview of some embodiments of the present technology, an example computing environment in which embodiments of the present technology may be implemented is described below in order to provide a general context for various aspects of the present technology. Referring now to FIG. 8 in particular, an example operating environment for implementing embodiments of the present technology is shown and designated generally as computing device 800. Computing device 800 is but one example of a suitable computing environment and is not intended to suggest any limitation as to the scope of use or functionality of the technology. Computing device 800 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810, which directly or indirectly couples the following devices: memory 812, one or more processors 814, one or more presentation components 816, input/output (I/O) ports 818, input/output components 820, and illustrative power supply 822. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 8 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 8 and with reference to “computing device.”

Computing device 800 typically includes a variety of computer-readable media. Computer-readable media can be any available media that can be accessed by computing device 800 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 800. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 812 includes computer-storage media in the form of volatile or non-volatile memory. The memory may be removable, non-removable, or a combination thereof. Example hardware devices include solid-state memory, hard drives, optical-disc drives, etc. Computing device 800 includes one or more processors that read data from various entities, such as memory 812 or I/O components 820. Presentation component(s) 816 presents data indications to a user or other device. Example presentation components include a display device, speaker, printing component, vibrating component, etc.

I/O ports 818 allow computing device 800 to be logically coupled to other devices, including I/O components 820, some of which may be built-in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 800. Computing device 800 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 800 may be equipped with accelerometers or gyroscopes that enable detection of motion. The output of the accelerometers or gyroscopes may be provided to the display of computing device 800 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, components for optimizing text-based input to generate images for image-based searching can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to image reducing engine 110, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as data store 112. Moreover, functions of image reducing engine 110, among other functions, may be performed by server 110, computing device 108, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that may be practiced from the forgoing description include, but are not limited to the following examples:

Aspect 1: A system comprising: a camera; and at least one processor communicatively coupled to the camera and to one or more computer readable media having instructions stored thereon that cause the at least one processor to perform operations comprising: capturing live video imagery using the camera, the live video imagery being captured with a field of view (FOV) of the camera; determining a tracking device position of a tracking device relative to the camera; and transmitting a reduced live video imagery view from within the FOV determined from the tracking device position relative to the camera.

Aspect 2: A computer-implemented method comprising: receiving live video imagery, the live video imagery being captured with a FOV of a camera; based on a tracking device position of a tracking device relative to the camera, determining a reduced live video imagery view from within the FOV; and transmitting the reduced live video imagery view for display at a display device.

Aspect 3: One or more computer storage media having computer-executable instructions embodied thereon that, when executed by one or more processors, cause the one or more processors to perform operations comprising: receiving live video imagery, the live video imagery being captured with a FOV of a camera; reducing the live video imagery to provide a reduced live video imagery view based on a tracking device position of a tracking device relative to the camera; and transmitting the reduced live video imagery view from within the FOV for display at a display device.

Aspect 4: Any of Aspects 1-3, wherein the tracking device position is determined based on movement of the tracking device relative to movement of the camera.

Aspect 5: Any of Aspects 1-4, determining a change in the tracking device position relative to the camera; and transmitting a different reduced live video imagery view corresponding to the changed position of the tracking device.

Aspect 6: Any of Aspects 1-5, wherein the reduced live video imagery view is a live stream video segment of the FOV.

Aspect 7: Any of Aspects 1-6, wherein the reduced live video imagery view is determined by: identifying a location within the FOV of the camera that corresponds to the relative tracking device position of the tracking device; and determining an area around the location within the FOV, the area having a reduced set of dimensions relative to the FOV of the camera, wherein live video corresponding to the determined area is transmitted as the live stream video segment.

Aspect 8: Any of Aspects 1-7, wherein the FOV of the camera is greater than 120 degrees and wherein the reduced live video imagery view corresponds to a portion of the FOV that is less than 90 degrees.

Aspect 9: Any of Aspects 1-8, wherein the camera is wirelessly coupled to the at least one processor.

What is claimed is:

1. A system comprising:
a camera; and
at least one processor communicatively coupled to the camera and to one or more computer readable media having instructions stored thereon that cause the at least one processor to perform operations comprising:
capturing live video imagery using the camera, the live video imagery being captured with a field of view (FOV) of the camera;
determining a tracking device position of a tracking device relative to the camera; and
transmitting a reduced live video imagery view from within the FOV determined from the tracking device position relative to the camera.

2. The system of claim 1, wherein the tracking device position is determined based on movement of the tracking device relative to movement of the camera.

3. The system of claim 1, the operations further comprising:
determining a change in the tracking device position relative to the camera; and
transmitting a different reduced live video imagery view corresponding to the changed position of the tracking device.

4. The system of claim 1, wherein the reduced live video imagery view is a live stream video segment of the FOV.

5. The system of claim 4, wherein the reduced live video imagery view is determined by:
identifying a location within the FOV of the camera that corresponds to the relative tracking device position of the tracking device; and
determining an area around the location within the FOV, the area having a reduced set of dimensions relative to the FOV of the camera, wherein live video corresponding to the determined area is transmitted as the live stream video segment.

6. The system of claim 1, wherein the FOV of the camera is greater than 120 degrees and wherein the reduced live video imagery view corresponds to a portion of the FOV that is less than 90 degrees.

7. The system of claim 1, wherein the camera is wirelessly coupled to the at least one processor.

8. A computer-implemented method comprising:
receiving live video imagery, the live video imagery being captured with a field of view (FOV) of a camera;
based on a tracking device position of a tracking device relative to the camera, determining a reduced live video imagery view from within the FOV; and
transmitting the reduced live video imagery view for display at a display device.

9. The computer-implemented method of claim 8, wherein the tracking device position is determined based on movement of the tracking device relative to movement of the camera.

10. The computer-implemented method of claim 8, further comprising:
determining a change in the tracking device position relative to the camera; and
transmitting, for display at the display device, a different reduced live video imagery view corresponding to the changed tracking device position of the tracking device.

11. The computer-implemented method of claim 8, wherein the reduced live video imagery view is a live stream video segment of the FOV.

12. The computer-implemented method of claim 11, wherein the reduced live video imagery view is determined by:
identifying a location within the FOV of the camera that corresponds to the relative tracking device position of the tracking device; and
determining an area around the location within the FOV, the area having a reduced set of dimensions relative to the FOV of the camera, wherein live video corresponding to the determined area is transmitted as the live stream video segment.

13. The computer-implemented method of claim 8, wherein the FOV of the camera is greater than 120 degrees and wherein the reduced live video imagery view corresponds to a portion of the FOV that is less than 90 degrees.

14. The computer-implemented method of claim 8, wherein the camera is wirelessly coupled to the at least one processor.

15. One or more computer storage media having computer-executable instructions embodied thereon that, when executed by one or more processors, cause the one or more processors to perform operations comprising:
receiving live video imagery, the live video imagery being captured with a field of view (FOV) of a camera;
reducing the live video imagery to provide a reduced live video imagery view based on a tracking device position of a tracking device relative to the camera; and
transmitting the reduced live video imagery view from within the FOV for display at a display device.

16. The one or more computer storage media of claim 15, wherein the tracking device position is determined based on movement of the tracking device relative to movement of the camera.

17. The one or more computer storage media of claim 15, the operations further comprising:
determining a change in the tracking device position relative to the camera; and
transmitting, for display at the display device, a different reduced live video imagery view corresponding to the changed tracking device position of the tracking device.

18. The one or more computer storage media of claim 15, wherein the reduced live video imagery view is a live stream video segment of the FOV.

19. The one or more computer storage media of claim 18, wherein the reduced live video imagery view is determined by:
identifying a location within the FOV of the camera that corresponds to the relative tracking device position of the tracking device; and
determining an area around the location within the FOV, the area having a reduced set of dimensions relative to the FOV of the camera, wherein live video corresponding to the determined area is transmitted as the live stream video segment.

20. The one or more computer storage media of claim 15, wherein the FOV of the camera is greater than 120 degrees and wherein the reduced live video imagery view corresponds to a portion of the FOV that is less than 90 degrees.
